(19) United States
(12) Patent Application Publication
(10) Pub. No.: US 2024/0281735 A1
(43) Pub. Date: Aug. 22, 2024

(54) METHODS FOR REAL-TIME OPTIMIZING OF PROCUREMENT OF COMPUTING EQUIPMENT AND DEVICES THEREOF

(71) Applicant: Jones Lang LaSalle IP , Inc., Chicago, IL (US)

(72) Inventors: Mukut Ranjan Kalita, Vancouver (CA); Sujit Goswami, Carmichael, CA (US); Pinak Dash, San Jose, CA (US); Jayanth Chennamangalam, Vancouver (CA)

(21) Appl. No.: 18/111,946

(22) Filed: Feb. 21, 2023

(51) Int. Cl. G06Q 10/0631

(52) U.S. Cl. CPC G06Q 10/06313; G06Q 10/063118

(57) ABSTRACT

This technology retrieves new-employee job data for new employees from databases. A first machine learning model (MLM) is deployed to identify which of the new employees require acquisition of computing equipment based on the retrieved new-employee job data. The first MLM is trained based on a first training dataset created from: existing-employee job data associated with existing employees; and corresponding existing-employee computer data associated with the computing equipment assigned to at least a portion of the existing employees. A second MLM is deployed to identify the computing equipment to acquire for the identified new employees. The second MLM is trained based on a second training dataset created from a part of the first training dataset associated with the identified existing employees that required acquisition of the computing equipment. The acquisition of orders for the identified computer equipment for the identified new employees is initiated.

### FIELD

This technology relates to methods, non-transitory computer readable medium, and devices for real-time optimizing of procurement of computer equipment for employees of an entity.

### BACKGROUND

Historically, the identification and acquisition of computing equipment for new employees of an entity has been highly inefficient, inaccurate, and ineffective. By way of example, when a new employee has been hired to fulfill a specific job on an established start date, typically a manager of new employee will manually determine if computing equipment for the new employee is needed. Based on that determination, the manager will manually select the specifications for the needed computing equipment based on personal judgment. The manager will then create a formal request for the computing equipment which is ordered, processed and then provided to new employee.

Unfortunately, this prior process not only results in incorrect allocations of computing equipment, but also fails to analyze and provide for any effective optimizations of this identification and procurement process which simply is not possible for any individual to do. As a result, managers often over or under provision the computing equipment for an employee which is either cost inefficient or performance inefficient because it negatively impacts the employee s ability to carry out the job. Additionally, managers are often untrained to make these types of determinations and they are simply unable to identify and access and then make necessary cross-correlations and analysis of data to identify opportunities for any increase in efficiency of this process. These managers are also unable to analyze and determine what may be other optimization alternatives via prior purchase or use of existing available inventory of computing equipment that may be available. Further, any incorrect allocation of computing equipment is only detected after new employee receives the equipment, and this results in inefficient and ineffective use of the manager's and new employee's time.

### SUMMARY

A method for real-time optimizing of procurement of computer equipment includes retrieving new-employee job-related data based on new-employee identification data for each of one or more new employees of an entity from one or more databases. A first machine learning model is deployed to identify which of the one or more new employees require acquisition of the computing equipment based on the retrieved new-employee job-related data for each of one or more new employees. The first machine learning model is trained based on a first training dataset created from at least a portion of: existing-employee job-related data associated with existing employees of the entity collected; and corresponding existing-employee computer procurement data associated with the computing equipment assigned to at least a portion of the existing employees. A second machine learning model is deployed to identify the type of computing equipment to acquire for the identified one or more new employees who are identified as to require acquisition of the computing equipment, wherein the second machine learning model is trained based on a second training dataset created from a part of the first training dataset associated with the identified one or more of the existing employees that required acquisition of the computing equipment. The acquisition of one or more orders for the identified computer equipment for the identified one or more new employees is initiated.

A computing device with memory including programmed instructions stored thereon and one or more processors configured to execute the stored programmed instructions to retrieve new-employee job-related data based on new-employee identification data for each of one or more new employees of an entity from one or more databases. A first machine learning model is deployed to identify which of the one or more new employees require acquisition of the computing equipment based on the retrieved new-employee job-related data for each of one or more new employees. The first machine learning model is trained based on a first training dataset created from at least a portion of: existing-employee job-related data associated with existing employees of the entity collected; and corresponding existing-employee computer procurement data associated with computing equipment assigned to at least a portion of the existing employees. A second machine learning model is deployed to identify the type of computing equipment to acquire for the identified one or more new employees, wherein the second machine learning model is trained based on a second training dataset created from a part of the first training dataset associated with the identified one or more of the existing employees that required acquisition of the computing equipment. The acquisition of one or more orders for the identified computer equipment for the identified one or more new employees is initiated.

A non-transitory computer readable medium having stored thereon instructions that includes executable code that, when executed by one or more processors, causes the one or more processors to retrieve new-employee job-related data based on new-employee identification data for each of one or more new employees of an entity from one or more databases. A first machine learning model is deployed to identify which of the one or more new employees require acquisition of the computing equipment based on the retrieved new-employee job-related data for each of one or more new employees. The first machine learning model is trained based on a first training dataset created from at least a portion of: existing-employee job-related data associated with existing employees of the entity that is collected from one or more of the databases; and corresponding existing-employee computer procurement data associated with the computing equipment assigned to at least a portion of the existing employees from the one or more databases. A second machine learning model is deployed to identify the type of computing equipment to acquire for the identified one or more new employees, wherein the second machine learning model is trained based on a second training dataset created from a part of the first training dataset associated with the identified one or more of the existing employees that required acquisition of the computing equipment. The acquisition of one or more orders for the identified computer equipment for the identified one or more new employees is initiated.

This technology provides a number of advantages including providing methods, non-transitory computer readable media, and computing devices that enable real-time optimizing of procurement of computer equipment for employees of an entity. Examples of this technology are able to access and analyze with trained machine learning models a variety of different types of data, such as job-related data and computer procurement data, for existing employees at the same or different entities to optimize in real time procurement of computer equipment for new employees. With this technology, a variety of different cross-correlations between job-related data and computer procurement data for existing employees can be identified by the trained machine learning models, such as optimized configurations and acceptable tolerances for computing equipment based on multiple types of parameters from corresponding job-related data. By way of example, new machine learning models can be trained on data from similarly situated existing employee's data to determine optimization for procurement of computing equipment or for utilizing available existing computing equipment data when determined to fit within defined or analyzed and determined performance tolerances based on prior work performance history.

### BRIEF DESCRIPTION OF THE DRAWINGS

FIG. 1 is a block diagram of an exemplary network environment with a procurement management computing device;

FIG. 2 is a block diagram of an exemplary procurement management computing device;

FIG. 3 is a flowchart of an exemplary method for real-time optimizing of procurement of computer equipment;

FIG. 4 a flowchart of an exemplary method for training multiple machine learning models in real-time optimization of procurement of computer equipment;

FIG. 5 is a functional block diagram of exemplary merging of employee job-related data and computer procurement data for use in training of a machine learning inference systems with multiple machine learning models; and

FIG. 6 is functional block diagram illustrating exemplary application of multiple machine learning models in real-time optimization of procurement of computer equipment.

### DETAILED DESCRIPTION

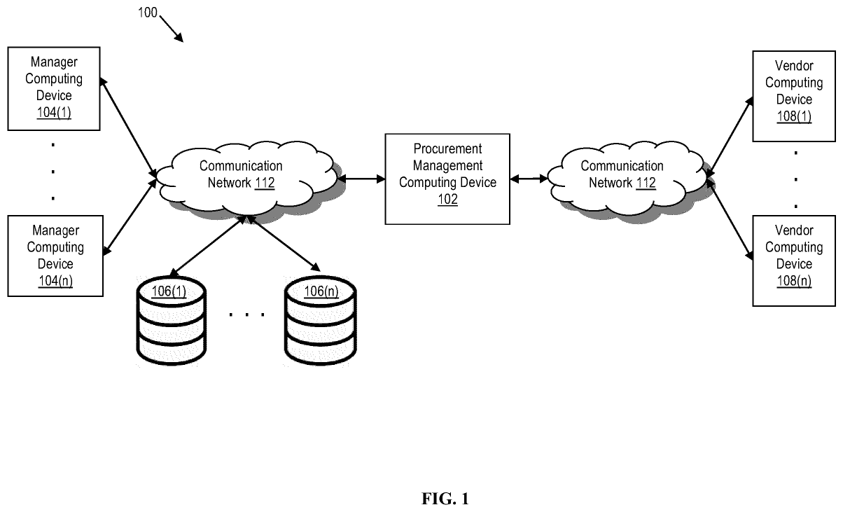

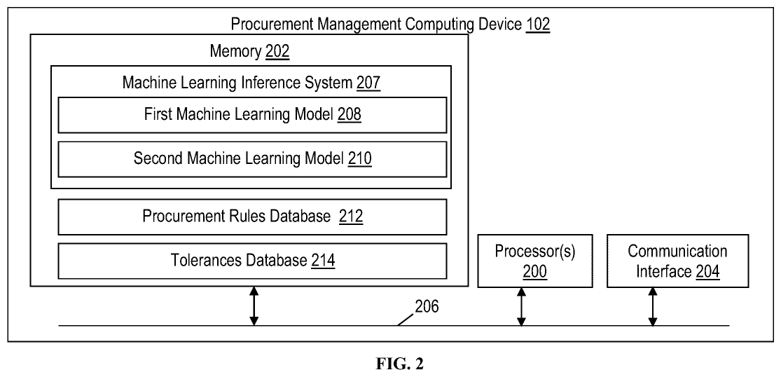

A network environment 100 with an exemplary procurement management computing device 102 configured to provide real-time optimization of procurement of computer equipment is shown in FIGS. 1 and 2. In this particular example, the environment 100 includes the procurement management computing device 102, manager computing devices 104(1)-104(n), databases 106(1)-106(n), and vendor computing devices 108(1)-108(n) which are coupled together via communication networks 112, although the environment could have other types and/or numbers of other systems, devices, components, and/or other elements in other configurations. In examples herein, existing employees may comprise current employees and/or historic employees and new employees may comprise new recent hire employees and/or current employees, such as ones switching jobs or other roles for example, in need of new computing equipment, such as for a new job assignment as an example, although other categorizations of these groups may be used in other examples. This technology provides several advantages including providing methods, non-transitory computer readable media, and computing devices that enable real-time optimizing of procurement of computer equipment for particular employees of an entity.

Referring more specifically to FIGS. 1 and 2, the procurement management computing device 102 of the network environment 100 may perform a number of different functions and/or other operations as illustrated and described by way of the examples herein, including training and deploying a machine learning inference system 207 with at least first and second machine learning models 208 and 210 to optimize identification of who requires computer equipment, configurations of that computer equipment, and procurement of that computer equipment by way of example The procurement management computing device 102 in this example includes processor(s) 200, a memory 202, and a communication interface 204, which are coupled together by a bus 206, although the procurement management computing device 102 can include other types or numbers of elements in other configurations.

The processor(s) 200 of the procurement management computing device 102 may execute programmed instructions stored in the memory 202 of the procurement management computing device 102 for any number of the functions and other operations as illustrated and described by way of the examples herein. The processor(s) 200 may include one or more central processing units (CPUs) or general purpose processors with one or more processing cores, for example, although other types of processor(s) can also be used.

The memory 202 of the procurement management computing device 102 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store applications that can include computer executable instructions that, when executed by the procurement management computing device 102, cause the procurement management computing device 102 to perform actions, such as to transmit, receive, or otherwise process network messages relating to new employees and requests for identifying and optimizing procurement of computer equipment as illustrated and described by way of the examples here. The application(s) can be implemented as components of other applications, operating system extensions, and/or plugins, for example.

Further, the application(s) may be operative in a cloud-based computing environment with access provided via a software-as-a-service model. The application(s) can be executed within or as virtual machine(s) or virtual server(s) that may be managed in a cloud-based computing environment. Also, the application(s), and even the procurement management computing device 102 itself, may be located in virtual server(s) running in a cloud-based computing environment rather than being tied to specific physical network computing devices. Also, the application(s) may be running in virtual machines (VMs) executing on the procurement management computing device 102 and managed or supervised by a hypervisor.

The memory 202 includes the machine learning inference system 207 with at least the first machine learning model 208 and the second machine learning model 210, a procurement rule database 212, and a tolerances database 214, although the memory may comprise other types and/or numbers of other modules, engines, programmed instructions and/or data.

In this example, the machine learning inference system 207 is configured to deploy or operationalize the processing of new employee job-related data and feeding this data into trained algorithms in the first machine learning model 208 and the second machine learning model 210 to identify which new employees require computing equipment and identifying the particular types and configurations of that computing equipment and then initiating procurement of that computing equipment, although the systems may execute other types and/or numbers of other functions and/or operations in other examples.

The first machine learning model 208 is trained to identify which of one or more new employees require acquisition of computing equipment based on retrieved new-employee job-related data for each of one or more new employees as illustrated and described by way of the examples herein, although this first machine learning model 208 may be trained to execute other types and/or functions or other operations to facilitate examples of this technology. By way of example, the first machine learning model 208 may be trained based on a first training dataset created from at least a portion of: existing-employee job-related data associated with existing employees of one or more entities; and corresponding existing-employee computer procurement data associated with the computing equipment assigned to at least a portion of the existing employees for the one or more entities from one or more databases 106(1)-106(n) to determine when computing equipment should be procured based on identified correlations in this data, although other types and/or combinations of data may be used for training as illustrated and described by way of examples herein. By way of further example, the first machine learning model 208 may be trained to learn that new employees with certain machine learning identified types of job-related data have computer equipment procurement decisions optimized when correlated to one set of existing employees with the same machine learning correlated types of job-related data as opposed to one or more other sets of existing employees who did not have any computer equipment procured based on stored result or performance history data for these sets of existing employees Accordingly, examples of this technology enable a variety of unique and different cross-correlations between particular types of job-related data and computer procurement data for identifying which new employees require computing equipment based on training the machine learning model 208 which otherwise could not be identified, although other manners for identifying which employees need new computing equipment may be used.

In this example, the second machine learning model 210 is trained to identify the computer equipment including particular configurations or other specifications, such as model identification data, manufacturer identification data, processor identification data, and memory identification data by way of example only, to acquire for the identified one or more new employees, although this second machine learning model 210 may be trained to execute other types and/or functions or other operations to facilitate examples of this technology. By way of further example, the second machine learning model 210 may be trained based on a second training dataset created from a part of the first training dataset associated with the identified one or more of the existing employees that required acquisition of the computing equipment, although other types and/or combinations of data may be used for training as illustrated and described by way of examples herein. By way of an even further example, the second machine learning model 210 may be trained to learn that new employees with certain types of job-related data have optimized computer equipment configuration decisions when correlated to certain particular configurations or other specifications of computing equipment identified with at least a portion of the existing employees that required acquisition of the computing equipment with stored employee performance data above certain thresholds or other metrics. In another example, the second machine learning model 210 also may be trained to analyze one or more procurement rules for a particular entity, such as certain requirements and/or certain restrictions specific to the entity, which are executed to adjust the particular specifications of the computing equipment to be procured. In a further example, the second machine learning model 210 also may be trained to analyze one or more tolerance rules for a particular entity, such as certain ranges or tolerances for specifications for certain types of the job-related data to adjust the particular specifications of the computing equipment to be procured. Even further, the second machine learning model 210 also may be trained to analyze existing inventory of computing equipment at a particular entity and then optimize use of existing computing equipment within permitted procurement rules from stored procurement rules 212 and/or retrieved tolerances from the tolerances database 214 by way of example. Accordingly, examples of this technology enable a variety of unique and different cross-correlations between particular types of job-related data and computer procurement data for determining particular computing specifications for computing equipment to procure for new employees.

The procurement rule database 212 has stored executable procurement rules for employees at different entities, such as ones based on job function, job type, job title, and/or cost centers, by way of example only, although these rules could be stored elsewhere and other types and/or combinations of rules or programmed instructions on procurement may be used as illustrated and described by way of examples herein.

The tolerances database 214 stores tolerance data for ranges or thresholds for aspects of computer specifications for computing equipment for existing employees from one or more entities, although this data could be stored elsewhere and other types and/or combinations of tolerance data may be used as illustrated and described by way of examples herein.

The communication interface 204 of the procurement management computing device 102 operatively couples and communicates between the procurement management computing device 102 and one or more of the manager computing devices 104(1)-104(n), the databases 106(1)-106(n), and/or the vendor computing devices 108(1)-108(n) via one or more communication networks 112, although other types or numbers of communication networks or systems with other types or numbers of connections or configurations to other devices or elements can also be used.

While the procurement management computing device 102 is illustrated in this example as including a single device, the procurement management computing device 102 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the procurement management computing device 102. Additionally, one or more of the devices that together comprise the procurement management computing device 102 in other examples can be standalone devices or integrated with one or more other devices or apparatuses.

In this example, each of the manager computing devices 104(1)-104(n) includes one or more processors, a memory, and a communication interface, which are coupled together by a bus or other communication link, although other types and/or numbers and types of components or other elements in other configurations could be used. Each of the manager computing devices 104(1)-104(n) is used to process or otherwise obtain new-employee job data for new employees and to initiate a process for real-time procurement of computing equipment.

The databases 106(1)-106(n) store new-employee and existing employees job data and existing employee computer-related data for one or more entities, although types and/or combinations of data and/or other programmed instructions may be stored and other storage locations may be used.

The vendor computing devices 108(1)-108(n) in this example respond to requests about particular computing equipment as well as interact with the real-time procurement of computer equipment, although the vendor computing devices 108(1)-108(n) may perform other types and/or numbers of other functions and/or operations as illustrated and described herein. Each of the vendor computing devices 108(1)-108(n) includes one or more processors, a memory, and a communication interface, which are coupled together by a bus or other communication link, although other types and/or numbers and types of components or other elements in other configurations could be used.

The communication networks 112 may be, for example, one or more of the same or different combinations of an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more such networks, although other types and/or numbers of networks in other topologies or configurations may be used.

In this particular example, the procurement management computing device 102, the manager computing devices 104(1)-104(n), the databases 106(1)-106(n), and the vendor computing devices 108(1)-108(n) are disclosed in FIG. 1 as dedicated hardware devices. However, one or more of the procurement management computing device 102, the manager computing devices 104(1)-104(n), the databases 106(1)-106(n), and the vendor computing devices 108(1)-108(n) can be implemented in software within one or more other devices in the network environment 100.

Although the exemplary network environment 100 with the procurement management computing device 102, the manager computing devices 104(1)-104(n), the databases 106(1)-106(n), and the vendor computing devices 108(1)-108(n) are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the procurement management computing device 102, the manager computing devices 104(1)-104(n), the databases 106(1)-106(n), and the vendor computing devices 108(1)-108(n), for example, may also be configured to operate as virtual instances on the same physical machine. In other words, one or more of the procurement management computing device 102, the manager computing devices 104(1)-104(n), the databases 106(1)-106(n), and the vendor computing devices 108(1)-108(n) may operate on the same physical device rather than as separate devices communicating through one or more communication networks 112.

The examples of this technology may also be embodied as one or more non-transitory computer readable media having instructions stored thereon, such as in the memory 202 by way of example, for one or more aspects of the present technology, as described and illustrated by way of the examples herein. The instructions in some examples include executable code that, when executed by one or more processors, such as the processor(s) 200, cause the processors to carry out steps necessary to implement the methods of the examples of this technology that are described and illustrated herein.

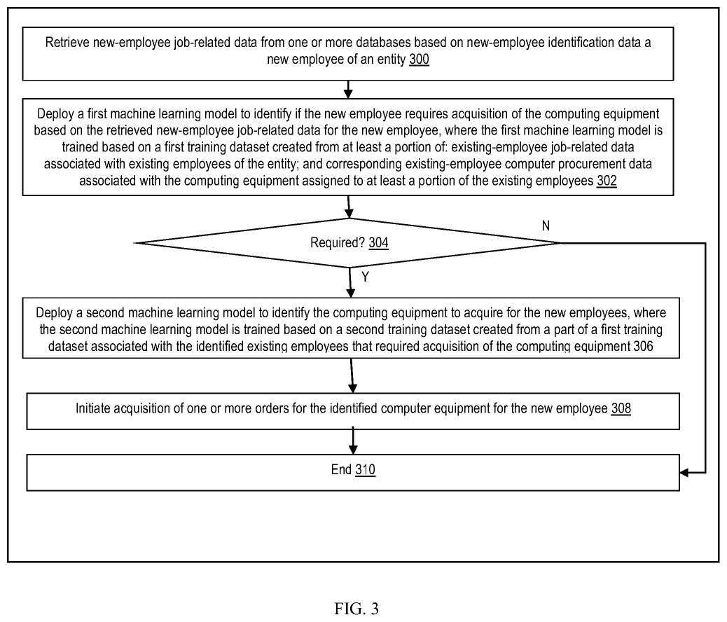

Referring to FIG. 1-6, an exemplary method for real-time optimizing of procurement of computer equipment is illustrated. More specifically, a flowchart of an exemplary method for real-time optimizing of procurement of computer equipment is illustrated in FIG. 3 and a functional block diagram illustrating an exemplary interaction of one of the manager computing devices 104(1) and the procurement management computing device 102 is illustrated.

In this example, in step 300 the procurement management computing device 102 in response to a request from a manager at one of the manager computing devices 104(1)-104(1) retrieves new-employee job-related data based on received new-employee identification data for each of one or more new employees of an entity from one or more databases 106(1)-106(n). A substantial amount and types of new-employee job related data can be obtained and utilized to identify dependencies and optimized combinations both for training and for optimized procurement, such as job location data, job type data, job title, job level data, job function data, job performance data, cost center data, and supporting market data by way of example only, although other types and/or combinations may be used.

By way of example, the new-employee and existing employee job-related data used for training and in deployment of the machine learning models 208 and 210 in the machine learning inference system 207 may comprise various machine learning identified numbers and combinations of:
Primary Work_Address_Country
   Country in which employee works.
      Values: [United States of America, India, China (Mainland), . . . ]
Location
   Location in which employee works.
      Values: [USA-CORP Chicago IL-Chicago, GBR-CORP London-30 Warwick Street, IND-CORP Gurugram-JBS-B3, IT SEZ, . . . ]
Workers_Job_Profile
   Job Profile
Values: [Engineering Services-S2, Property Mgmt Operations-B1, Facilities Services-O2, . . . ]
Job_Family
   Job Family
      Values: [Engineering/Maintenance/Building Services, Asset/Portfolio/Property Management, Administration & Operations, . . . ]
Workers_Job_Code
   V Code associated with a position.
      Values: [S10302, B10222, 010312, . . . ]
Workers_Management Level
   JLL defined management level of an employee.
      Values: [Professional 2, Building Operations 2, Producer 5, . . . ]
Workers_Worker_Type
   Contingent worker or full-time employee.
      Values: [Employee, Contingent Worker]
Workers_Company
   V Workers company
      Values: [*US AMR-Jones Lang LaSalle Americas, Inc., EAD-Jones Lang LaSalle Management Services Ltd, AJG-JLL Tetris Design & Build, BRA, . . . ]
Workers_Cost_Center
   Workers cost center
      Values: [325062_WD WPM—Facilities Mgmt, 325063_WD WPM—Static Engineering, 300002_Prop Mgmt—Office, . . . ]
Workers_F_CDS_ESI_Org_Type_Reimbursable
   V Identifies if charging back to the client for an employee's salary
      Values: [Y, N]
Workers_CFSYS_LO_Custom_Organization_HR_or_Non_HR
   Used to identify HR, and therefore security HR from seeing other HR users.
   Also passed downstream to HR Direct to flag people who can see all HR content/knowledge articles.
      Values: [Non-HR Users]
Workers_JLL_CF_CDS_ESI_Org_Type_Market
   Market identifies which market you support
      Values: [AM0001_US—National, GB1000_Global—Global Market, AM2561_US SE VA DC—Rchmnd Prj. MKP, . . . ]
Workers_JLL_CF_CDS_ESI_Org_Type_Function
   The function someone sits in—used along with Cost Center to get to deeper levels of the organization.
      Values: [2000_RG—Revenue Generator, 3012_SD—General Service Delivery, 3016_SD—Client Accounting, . . . ]
Workers_JLL_CF_CDS_ESI_Org_Type_Business_Unit
   Business Unit and Company
      Values: [US002_Jones Lang LaSalle America Inc, IN002_JLL Prop. Svcs (India) Private, AU003_JLL Australia Pty Limited, . . . ]
Workers_CF_ESI_Worker_Client_Organization
   The client a worker is associated to (if any). We have only about 400 top clients in Workday that are worth tracking, so it's not always 100% correct when it says *No Client, as they may be in a client in PS that's just too small to make the list
      Values: [*No Client, AMZ FC US, HSBC Holdings Plc, . . .
Managers_Company
   Managers company
      Values: [*US AMR-Jones Lang LaSalle Americas, Inc., EAD-Jones Lang LaSalle Management Services Ltd, JAA-Jones Lang LaSalle Limited, . . . ]
Managers_Cost_Center
   Managers cost center
      Values: [325062_WD WPM—Facilities Mgmt, 325066_WD WPM—Support Services, 200035_Leasing—GIS, . . . ]
Managers_JLL_CF_CDS_ESI_Org_Type_Reimbursable
   Reimbursable
      Values: [N, Y]
Managers_JLL_CFSYS_LO_Custom_Organization_HR_or_Non_HR
   HR non-HR
      Values: [Non-HR Users, HR Users]
Managers_CF_ESI_Worker_Client_Organization
   Client organization
      Values: [*No Client, Amazon GREF, Australian Postal Corporation, . . . ]
Managers_JLL_CF_CDS_ESI_Org_Type_Market
   Market
      Values: [AP1011_CN—Shanghai, AM0001_US—National, AP1112_CN—Dalian, . . . ]
Managers_JLL_CF_CDS_ESI_Org_Type_Function
   Function
      Values: [2000_RG—Revenue Generator, 3003_SD—Account Management, 2023_RG—Property—Debt Financing, . . . ]
Managers_JLL_CF_CDS_ESI_Org_Type_Business_Unit
   Business unit
      Values: [US002_Jones Lang LaSalle America Inc, IN002_JLL Prop. Svcs (India) Private, AU003_JLL Australia Pty Limited, . . . ]
Position
   Name of the position the employee is in.
      Values: [Specialist, Engineering Services, Building Operations, Facilities Services, Professional, Facilities Management Support,
Business_Title
   Business title of the employee.
      Values: [Operating Engineer, Facilities Coordinator, Facilities Manager, . . . ]
Job_Title
   Job title of the employee.
      Values: [Specialist, Engineering Services, Building Operations, Facilities Services, Professional, Facilities Management Support,
Job_Category
   Job Category
      Values: [Business Support, Professional, No Category, . . . ]
Job_Family_Group
   Job Family group
      Values: [Engineering/Maintenance/Building Services Group, Facilities Management Group, Digital Group, . . . ]
Employee_Type
   Type of an employee.
      Values: [Regular, CHN & HKG PAM No WD, Qualified Real Estate Agent, . . . ]
Time_Type
   Full-time or part-time employee.
      Values: [Full time, part time]
FTE
   Compared to a full-time employee what fraction of time employee works at an entity.
      Values: [1, 0.8, 0.4571, . . . ]

As illustrated above a variety of types of new-employee job-related data and existing-employee job-related data which can be categorized into types, such as job location data, job type data, job title, job level data, job function data, job performance data, cost center data, and supporting market data by way of example, with defined parameters that have assigned values may be utilized. In some example, the machine learning models, such as machine leaning models 208 and 210, may identify particular types and combinations of job-related data for determining when to procure computing equipment for a particular employee and then may have identified other particular types and combinations of job-related data for determining what particular configurations of computing equipment to procure which could not and would not be the same as what would be determined by a manager at one of the manager computing devices 104(1)-104(n).

By way of a further example, the existing employee computer procurement data used for training and during deployment of the machine learning models 208 and 210 in the machine learning inference system 207 may comprise:
Model
   Values: [Latitude 7420, HP EliteBook 840 G6, Surface Book, . . . ]
Manufacturer
   Values: [Dell Inc., Apple, Alienware, . . . ]
Processor
   Values: [Intel® Core™ i5-8365U CPU @ 1.60 GHz, 11th Gen Intel® Core™ i7-1185G7 @ 3.00 GHz, Intel® Core™ i9-9900 CPU @ 3.10 GHz, . . . ]
Memory

### Values: [16106.0, 16052.0, 12093.0, . . . ]

As illustrated above a variety of types of computer procurement data which can be categorized into types, such model identification data, manufacturer identification data, processor identification data, and memory identification data for the computer equipment by way of example, with defined parameters that have assigned values may be utilized.

In step 302, the procurement management computing device 102 deploys the trained first machine learning model 208 in the machine inference learning system 207 to determine which of the one or more new employees require acquisition of the computing equipment based on the retrieved new-employee job-related data for each of one or more new employees from one or more of the databases 106(1)-106(n) in this example, although the employees requiring new equipment can be identified in different manners.

As described earlier, the first machine learning model 208 may be trained to learn that new employees with certain machine learning identified types of job-related data have computer equipment procurement decisions optimized when correlated to one set of existing employees with the same machine learning correlated types of job-related data as opposed to one or more other sets of existing employees who did not have any computer equipment procured based on stored result or performance history data for these sets of existing employees. Accordingly, examples of this technology enable a variety of unique and different cross-correlations between particular types of job-related data and computer procurement data for identifying which new employees require computing equipment.

In this example, the first machine learning model 208 is trained based on a first training dataset created from at least a portion of: existing-employee job-related data associated with existing employees of the entity that is collected from one or more of the databases 106(1)-106(n); and corresponding existing-employee computer procurement data associated with the computing equipment assigned to at least a portion of the existing employees from the one or more databases 106(1)-106(n), although other types and/or combinations of data and other sources may be used in other examples.

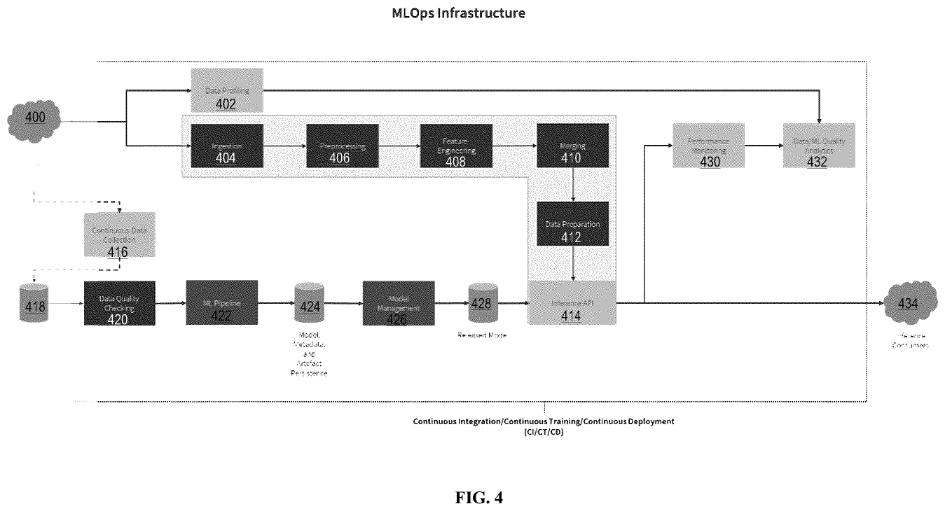

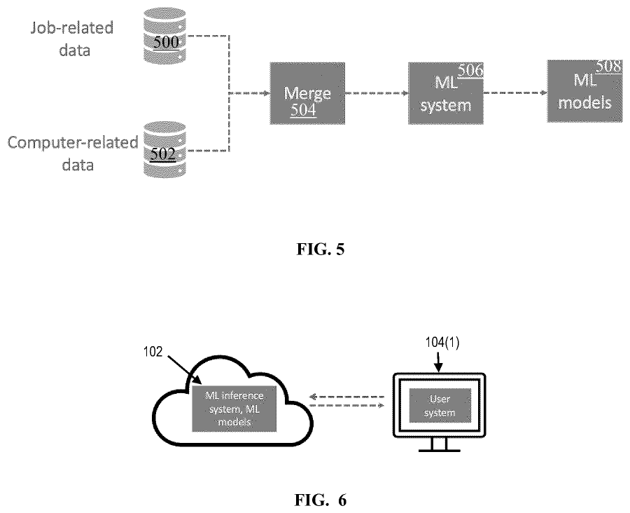

Referring to FIGS. 4 and 5, a flowchart of an exemplary method for training machine learning models 208 and 210 in real-time optimization of procurement decisions and configurations of computer equipment and a functional block diagram of exemplary merging of employee job-related data and computer procurement data for use in training of a machine learning inference systems with multiple machine learning models is shown. For ease of illustrated illustration, the steps are numbers in FIG. 4 and examples of the steps are provided herein.

Referring more specifically to the example FIG. 4, in step 400, the procurement management computing device 102 receives input job-related data, as illustrated and described by way of example earlier, which is used to make optimized predictions of which employees, such as a new employee or an employee who may be transitioned to a new job, needs computer equipment and of the optimized configuration of that computer equipment from the first and second machine learning models 208 and 210. For example, the input job-related data may be received based on a manager's input from one of the management computing device 104(1)-104(n) or this data may be provided to the procurement management computing device 102 and/or may be automatically identified and collected from, for example, an associated enterprise HR data platform, such as one at one or more of the databases 106(1)-106(n).

In step 402, the procurement management computing device 102 engages in data profiling of the received input job-related data to analyze and summarize what has been received. By way of example, the data profiling by the procurement management computing device 102 may check incoming data against a standard dataset and summarize any anomalies in the incoming dataset to provide analytics to ensure data meets agreed quality and standards, such visual analytics for a data scientist.

In step 404, the procurement management computing device 102 ingests and prepares the raw received input job-related data to be fed into the first machine learning model 208 and the second machine learning model 210. For example, the procurement management computing device 102 may convert any of the raw received input job-related data in .csv format to Pandas DataFrame, by way of example, based on the requirements of the machine learning models 208 and/or 210, although other types of data processing to facilitate machine learning may be used.

In step 406, the procurement management computing device 102 preprocesses the prepared input job-related data to feed into the machine learning models 208 and 210 in this example. For example, the preprocessing by the procurement management computing device 102 may comprise adjusting to lower cases all text, removing null values, and removing extra spaces in the prepared input job-related data, although other types of preprocessing may be executed.

In step 408, the procurement management computing device 102 executes feature engineering to generate new job-related data from the preprocessed input job-related data. For example, the procurement management computing device 102 may identify and break the preprocessed input job-related data containing multiple words into constituent words to facilitate training of the machine learning models 208 and/or 210. For example, the preprocessed input job-related data comprising, for example, “Facilities Services” can be separated into “Facilities” and “Services” and “Facilities Management Support” can be separated into “Facilities” “Management” and “Support”. This process of breaking the preprocessed input job-related data into constituent words may help the machine learning models 208 and/or 210 learn based on more inputs than unbroken inputs thereby allowing it to discover more complex connections of the output to its inputs.

In step 410, if multiple sets of the input and feature engineered job-related data are used, the procurement management computing device 102 merges them, in this example, into one dataset based on stored predefined criteria. An example of this merger is illustrated and described with reference to FIG. 5 herein.

In step 412, the procurement management computing device 102 converts all the merged job-related data to numerical representations to a numerical format that enables the processing for training of the machine learning models 208 and 210 in this example. For example, the procurement management computing device 102 converts text in the merged job-related data to numbers using various text to number conversion algorithms stored in memory 202 in this example.

In step 414, the procurement management computing device 102 makes an API call to make an inference on the converted job-related data the machine learning models 208 and/or 210. More specifically, in this example, the converted job-related data is fed to the machine learning models 208 and/or 210 using an API call and then the API sends back the predictions that are output of the machine learning models 208 and/or 210 as they are trained.

In step 416, the procurement management computing device 102 the procurement management computing device 102 may continue to facilitate continuous collection of job-related data so that the machine learning models 208 and 210 in this example can in real time continue to be updated to further optimize the computing equipment procurement decisions of who needs computing equipment and what configuration of computing equipment is optimized for the particular employee based on the job-related data for that particular employee.

In step 418, the procurement management computing device 102 uses historical data which may, for example, be obtained from one or more of the databases 106(1)-106(n) to also build and train the machine learning models 208 and 210.

In step 420, when the historical job-related data comes in, the procurement management computing device 102 checks for data quality based on previously chosen benchmarks. If the procurement management computing device 102 determines that the job-related data passes all quality checks, only then is the job-related data used in training which helps to further enhance the quality of the trained machine learning models 208 and 210.

In step 422, the procurement management computing device 102 periodically check available if the converted job-related data has drifted or changed based on or more benchmarks or thresholds to decide if new training of the trained machine learning models 208 and 210 is needed or not. Based on this check, the procurement management computing device 102 may execute further updated training of the machine learning models 208 and 210 if a sufficient data drift is identified.

In step 424, the procurement management computing device 102 obtains the results of the training of the machine learning models 208 and 210 which may for example include the currently trained version of the machine learning models 208 and 210, model meta data, and training reports.

In step 426, the procurement management computing device 102 may provide a real time decision on if and when to use one or more of the trained machine learning models 208 and 210.

In step 428, the procurement management computing device 102 may release one or more of the machine learning models 208 and 210, in this example, for use in computer equipment procurement as illustrated and described in examples herein.

In step 430, the procurement management computing device 102 monitors performance of the machine learning models 208 and 210 in this example by analyzing and storing predictions on live job-related data for new employees and may adjust the machine learning models 208 and 210 in this example based on that monitored performance if below a set benchmark or other threshold or eliminate a type of job-related data used in training if negatively impacting performance.

In step 432, the procurement management computing device 102 performs combined analysis of input job-related data to measure data quality and of performance metrics for the machine learning models 208 and 210 in this example, such as accuracy, precision and recall by way of example, and generates detailed reports which can be used to verify suitability of the machine learning models 208 and 210 in this example for use and/or to adjust the training of the machine learning models 208 and 210 in this example.

In step 434, the procurement management computing device 102 may serve generated inference results to users at one or more of the manager computing devices 104(1)-104(n) for any of the input job-related data that was received.

Referring to FIG. 5, in steps 500 and 502 existing employee job-related data and corresponding computer procurement data is obtained by the procurement management computing device 102 and is ingested, processed to cross correlate and merged together the employee job-related data and corresponding computer procurement data into a master training dataset in step 504. In steps 506 and 508, the procurement management computing device 102 executes the machine uses the machine learning models 208 and 210 with the master training dataset as illustrated and described by way of the examples herein.

Referring back to FIG. 3, in step 304 the procurement management computing device 102 determines whether the new employee needs procurement of computing equipment based on the obtained new employee job-related data input and processed by the first machine learning model 208. If in step 304 the procurement management computing device 102 determines the new employee does not need procurement of computing equipment based on execution of the machine learning model 208 on the job-related data for the new employee, then the No branch is taken to step 310 where this example of the method may end. If in step 304 the procurement management computing device 102 determine the new employee needs procurement of computing equipment based on execution of the machine learning model 208 on the job-related data for the new employee, then the Yes branch is taken to step 306.

In step 306 the procurement management computing device 102 uses a second machine learning model 210 to identify the configuration or other specifications for the computing equipment to acquire for the identified one or more new employees. In this example, the second machine learning model 210 is trained based on a second training dataset created from a part of the first training dataset associated with the identified one or more of the existing employees that required acquisition of the computing equipment.

As described earlier, the second machine learning model 210 may, by way of example, be trained based on a second training dataset created from a part of the first training dataset associated with the identified one or more of the existing employees that required acquisition of the computing equipment, although other types and/or combinations of data may be used for training as illustrated and described by way of examples herein. By way of example, the second machine learning model 210 may be trained to learn that new employees with certain types of job-related data have optimized computer equipment configuration decisions when correlated to certain particular configurations or other specifications of computing equipment identified with at least a portion of the existing employees that required acquisition of the computing equipment with stored employee performance data above certain thresholds or other metrics. In another example, the second machine learning model 210 also may be trained to analyze one or more procurement rules for a particular entity, such as certain requirements and/or certain restrictions specific to the entity, which are executed to adjust the particular specifications of the computing equipment to be procured. In a further example, the second machine learning model 210 also may be trained to analyze one or more tolerance rules for a particular entity, such as certain ranges or tolerances for specifications for certain types of the job-related data to adjust the particular specifications of the computing equipment to be procured. Even further, the second machine learning model 210 also may be trained to analyze existing inventory of computing equipment at a particular entity and then optimize use of existing computing equipment within permitted procurement rules from stored procurement rules 212 and/or retrieved tolerances from the tolerances database 214 by way of example. Accordingly, examples of this technology enable a variety of unique and different cross-correlations between particular types of job-related data and computer procurement data for determining particular computing specifications for computing equipment to procure for new employees.

In step 308, the procurement management computing device 102 initiates the acquisition of one or more orders for the identified computer equipment for the identified one or more new employees based on the identification of the particular specifications for the computing equipment. By way of example, the procurement management computing device 102 may initiate an automated procurement of the identified computing equipment from one of the vendor computing devices 108(1)-108(n), although the computing equipment can be obtained from other sources and in other manners. By way of another example, the procurement management computing device 102 may identify at least a portion of the identified computing equipment to be procured is in storage and may initiate an automated request for that equipment as well as any necessary modifications to the computing equipment to satisfy the identified computer specifications, such as updating memory in the computing equipment by way of example. Next, this example of this process may end in step 310.

As described and illustrated by way of the examples herein, this technology provides methods, non-transitory computer readable media, and computing devices that enable real-time optimizing of procurement of computer equipment for employees of an entity. Examples of this technology are able to access and analyze with trained machine learning models a variety of different types of data, such as job-related data and computer procurement data, for existing employees at the same or different entities to optimize in real time procurement of computer equipment for new employees. With this technology, a variety of different cross-correlations between job-related data and computer procurement data for existing employees can be identified by the trained machine learning models, such as optimized configurations and acceptable tolerances for computing equipment based on multiple types of parameters from corresponding job-related data. By way of example, machine learning models can be trained on data from similarly situated existing employees to determine optimization for computer equipment or for utilizing available existing computer equipment when determined to fit within defined or analyzed and determined performance tolerances based on prior work performance history.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method implemented by one or more computing devices, the method comprising:
retrieving new-employee job-related data based on new-employee identification data for each of one or more new employees of an entity from one or more databases;
deploying a first machine learning model to identify which of the one or more new employees require acquisition of the computing equipment based on the retrieved new-employee job-related data for each of one or more new employees, wherein the first machine learning model is trained based on a first training dataset created from at least a portion of:
existing-employee job-related data associated with existing employees of the entity collected; and
corresponding existing-employee computer procurement data associated with the computing equipment assigned to at least a portion of the existing employees;
deploying a second machine learning model to identify the computing equipment to acquire for the identified one or more new employees, wherein the second machine learning model is trained based on a second training dataset created from a part of the first training dataset associated with the identified one or more of the existing employees that required acquisition of the computing equipment; and
initiating acquisition of one or more orders for the identified computing equipment for the identified one or more new employees.

2. The method as set forth in claim 1 wherein the second machine learning model is trained to identify specification data for the computing equipment acquired for the identified one or more of the existing employees.

3. The method as set forth in claim 2 wherein the initiating the acquisition of the one or more orders for the identified computer equipment for the identified one or more new employees further comprises:
identifying the specification data for the computing equipment to acquire for the identified one or more new employees; and
initiating acquisition of the one or more orders based on the identified specification data for the new computer equipment for the identified one or more new employees.

4. The method as set forth in claim 2 wherein the specification data further comprises model identification data, manufacturer identification data, processor identification data, and memory identification data for the computer equipment.

5. The method as set forth in claim 1 wherein the new-employee job-related data and the existing-employee job-related data each comprise three or more of job location data, job type data, job title, job level data, job function data, job performance data, cost center data, and supporting market data.

6. The method as set forth in claim 1 the initiating the acquisition of the one or more orders for the identified computer equipment for the identified one or more new employees further comprises:
automating the one or more orders for the identified computer equipment for each of the identified one or more of the new employees.

7. The method as set forth in claim 1 wherein the initiating the acquisition of the one or more orders for the identified computing equipment for the identified one or more new employees further comprises:
identifying parts of the one or more orders for the identified computer equipment for each of the identified one or more of the new employees currently available at the entity.

8. The method as set forth in claim 7 wherein the initiating the acquisition of the one or more orders for the identified computer equipment for the identified one or more new employees further comprises:
identifying any alternative computer equipment available at the entity and within computing performance tolerances for the identified computer equipment for each of the identified one or more of the new employees.

9. The method as set forth in claim 7 wherein the initiating the acquisition of the one or more orders for the identified computer equipment for the identified one or more new employees further comprises:
automating the one or more orders for other parts of the one or more orders for the identified computer equipment for each of the identified one or more of the new employees currently unavailable at the entity.

10. A computing device, comprising memory comprising programmed instructions stored thereon and one or more processors configured to execute the stored programmed instructions to:
retrieve new-employee job-related data based on new-employee identification data for each of one or more new employees of an entity from one or more databases;
deploy a first machine learning model to identify which of the one or more new employees require acquisition of the computing equipment based on the retrieved new-employee job-related data for each of one or more new employees, wherein the first machine learning model is trained based on a first training dataset created from at least a portion of:
existing-employee job-related data associated with existing employees of the entity collected; and
corresponding existing-employee computer procurement data associated with the computing equipment assigned to at least a portion of the existing employees;
deploy a second machine learning model to identify the computing equipment to acquire for the identified one or more new employees, wherein the second machine learning model is trained based on a second training dataset created from a part of the first training dataset associated with the identified one or more of the existing employees that required acquisition of the computing equipment; and
initiate acquisition of one or more orders for the identified computer equipment for the identified one or more new employees.

11. The device as set forth in claim 10 wherein the second machine learning model is trained to identify specification data for the computing equipment acquired for the identified one or more of the existing employees.

12. The device as set forth in claim 11 wherein for the initiate the acquisition of the one or more orders for the identified computer equipment for the identified one or more new employees, the processors are further configured to execute the stored programmed instructions to:
identify the specification data for the computing equipment to acquire for the identified one or more new employees; and
initiate acquisition of the one or more orders based on the identified specification data for the new computing equipment for the identified one or more new employees.

13. The device as set forth in claim 11 wherein the specification data further comprises model identification data, manufacturer identification data, processor identification data, and memory identification data for the computing equipment.

14. The device as set forth in claim 10 wherein the new-employee job-related data and the existing-employee job-related data each comprise three or more of job location data, job type data, job title, job level data, job function data, job performance data, cost center data, and supporting market data.

15. The device as set forth in claim 10 wherein for the initiating the acquisition of the one or more orders for the identified computer equipment for the identified one or more new employees, the processors are further configured to execute the stored programmed instructions to:
automate the one or more orders for the identified computing equipment for each of the identified one or more of the new employees.

16. The device as set forth in claim 10 wherein for the initiating the acquisition of the one or more orders for the identified computer equipment for the identified one or more new employees, the processors are further configured to execute the stored programmed instructions to:
identify parts of the one or more orders for the identified computing equipment for each of the identified one or more of the new employees currently available at the entity.

17. The device as set forth in claim 16 wherein for the initiating the acquisition of the one or more orders for the identified computing equipment for the identified one or more new employees, the processors are further configured to execute the stored programmed instructions to:
identify any alternative computing equipment available at the entity and within computing performance tolerances for the identified computer equipment for each of the identified one or more of the new employees.

18. The device as set forth in claim 16 wherein for the initiating the acquisition of the one or more orders for the identified computing equipment for the identified one or more new employees, the processors are further configured to execute the stored programmed instructions to:
automate the one or more orders for other parts of the one or more orders for the identified computing equipment for each of the identified one or more of the new employees currently unavailable at the entity.

19. A non-transitory computer readable medium having stored thereon instructions comprising executable code which when executed by one or more processors, causes the processors to:
retrieve new-employee job-related data based on new-employee identification data for each of one or more new employees of an entity from one or more databases;
deploy a first machine learning model to identify which of the one or more new employees require acquisition of the computing equipment based on the retrieved new-employee job-related data for each of one or more new employees, wherein the first machine learning model is trained based on a first training dataset created from at least a portion of:
existing-employee job-related data associated with existing employees of the entity collected; and
corresponding existing-employee computer procurement data associated with the computing equipment assigned to at least a portion of the existing employees;
deploy a second machine learning model to identify the computing equipment to acquire for the identified one or more new employees, wherein the second machine learning model is trained based on a second training dataset created from a part of the first training dataset associated with the identified one or more of the existing employees that required acquisition of the computing equipment; and
initiate acquisition of one or more orders for the identified computing equipment for the identified one or more new employees.

20. The non-transitory computer readable medium as set forth in claim 19 wherein the second machine learning model is trained to identify specification data for the computing equipment acquired for the identified one or more of the existing employees.

21. The non-transitory computer readable medium as set forth in claim 20 wherein for the initiate the acquisition of the one or more orders for the identified computing equipment for the identified one or more new employees, the executable code when executed by the processors further causes the processors to:
identify the specification data for the computing equipment to acquire for the identified one or more new employees; and
initiate acquisition of the one or more orders based on the identified specification data for the new computing equipment for the identified one or more new employees.

22. The non-transitory computer readable medium as set forth in claim 20 wherein the specification data further comprises model identification data, manufacturer identification data, processor identification data, and memory identification data for the computing equipment.

23. The non-transitory computer readable medium as set forth in claim 19 wherein the new-employee job-related data and the existing-employee job-related data each comprise three or more of job location data, job type data, job title, job level data, job function data, job performance data, cost center data, and supporting market data.

24. The non-transitory computer readable medium as set forth in claim 19 wherein for the initiating the acquisition of the one or more orders for the identified computer equipment for the identified one or more new employees, the executable code when executed by the processors further causes the processors to:
automate the one or more orders for the identified computing equipment for each of the identified one or more of the new employees.

25. The non-transitory computer readable medium as set forth in claim 19 where for the initiating the acquisition of the one or more orders for the identified computing equipment for the identified one or more new employees, the executable code when executed by the processors further causes the processors to:
identify parts of the one or more orders for the identified computing equipment for each of the identified one or more of the new employees currently available at the entity.

26. The non-transitory computer readable medium as set forth in claim 25 where for the initiating the acquisition of the one or more orders for the identified computer equipment for the identified one or more new employees, the executable code when executed by the processors further causes the processors to:
identify any alternative computer equipment available at the entity and within computing performance tolerances for the identified computing equipment for each of the identified one or more of the new employees.

27. The non-transitory computer readable medium as set forth in claim 25 where for the initiating the acquisition of the one or more orders for the identified computer equipment for the identified one or more new employees, the executable code when executed by the processors further causes the processors to:
automate the one or more orders for other parts of the one or more orders for the identified computer equipment for each of the identified one or more of the new employees currently unavailable at the entity.
